(19) United States
(12) Patent Application Publication
(10) Pub. No.: US 2012/0011753 A1
(43) Pub. Date: Jan. 19, 2012

(54) POLYGONAL ILLUMINATED HAND SIGN

(76) Inventor: Miroslav Ivanovic, Long Island City, NY (US)

(21) Appl. No.: 13/182,985

(22) Filed: Jul. 14, 2011

Related U.S. Application Data
(60) Provisional application No. 61/364,192, filed on Jul. 14, 2010.

(51) Int. Cl. G09F 13/04

(52) U.S. Cl. 40/541

(57) ABSTRACT

An illuminated hand sign system for providing traffic information when there is no availability of permanently installed sign, for example at a traffic accident or a short term road construction site. The system containing a handle supporting a two-sided sign portion formed of two sign halves each providing a different bit of traffic information, and an illuminating element located in between the two sign halves, and a power source for the illuminating element. A switch is provided to activate the illuminating element so as to render the traffic information more visible both during the day and at night.

The application claims the benefit of priority pursuant to 35 U.S.C. 119(e) from a U.S. Provisional Patent Application having Application No. 61/364,192 filed Jul. 14, 2011.

### GENERAL BACKGROUND

The present invention relates generally to traffic signs, and more specifically to illuminated hand traffic signs of the type capable of being held in the hand or attached to the “limb” of a human, simulated human, or other object viewable by drivers of vehicles.

The present invention augments and improves upon the illuminated hand sign disclosed in my U.S. Design Patent No. Des. 400,462 granted on Nov. 3, 1998, upon underlying patent application no. 81,392 filed on Dec. 31, 1997.

### Invention Background Context

a. Prior patent art believed to be relevant to the subject invention, although not anticipatory or suggestive of my present invention, includes the following U.S. Patents: Des. 185,605 to Kaiser granted in 1959; Des. 224,628 to Lamb granted in 1972; Des. 315,695 to DeCaro granted in 1991; Des. 351,807 to Smith et al. granted in 1994; and Des. 382,218 to Hall granted in 1997.

b. There have been other efforts to provide a hand sign, which are not anticipatory of my present invention, the specifics of which are not presently known to me.

### SUMMARY OF THE PRESENT INVENTION

The present invention teaches illuminated hand sign systems, and more particularly, to a traffic information sign, for new and improved polygonal illuminated hand sign systems for use in influencing vehicular traffic, as shown in the annexed drawings.

### BRIEF DESCRIPTION OF THE FIGURES

The following description of the annexed informal drawings are relevant to the present improved embodiment of the present invention:

a. FIG. 1 is a front elevational view of the polygonal (hexagonal) illuminated hand sign of the present invention;

b. FIG. 1A a front elevational view of another polygonal (octagonal) embodiment of the present invention

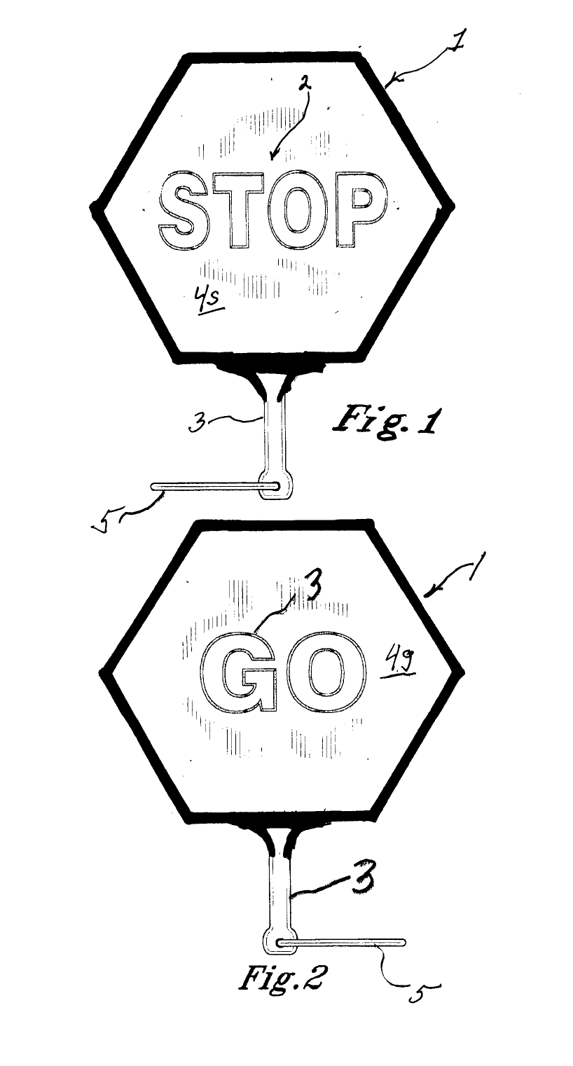

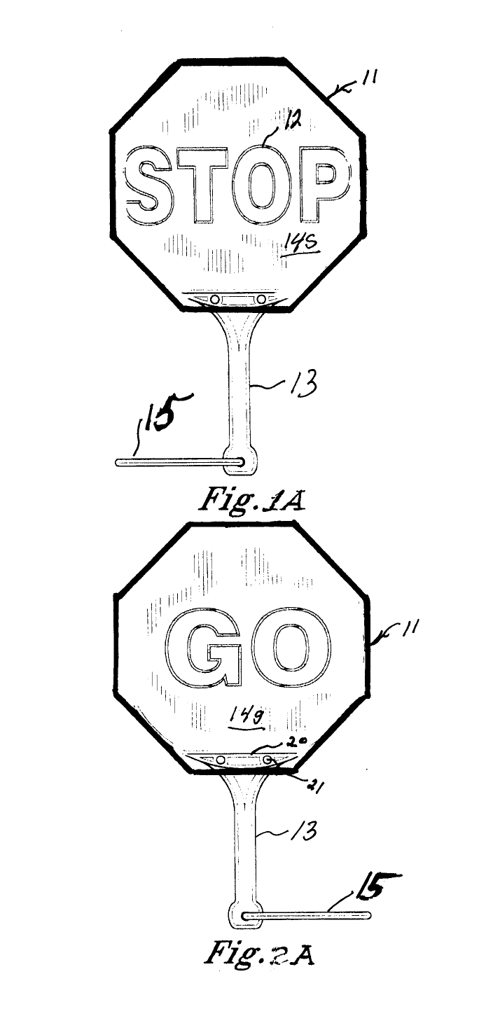

c. FIG. 2 is a rear elevational view of the polygonal (hexagonal) illuminated hand sign of FIG. 1;

d. FIG. 2A a rear elevational view of another polygonal (octagonal) embodiment of the present invention of FIG. 1A;

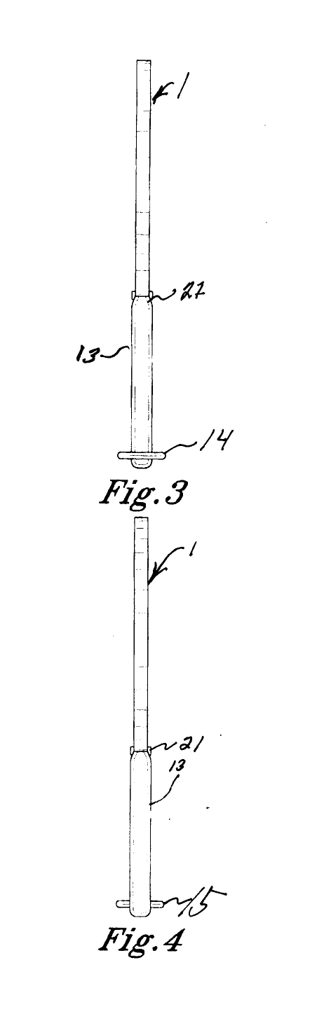

e. FIG. 3 is a left side elevational view of the polygonal illuminated hand sign of FIGS. 1 and 1A;

f. FIG. 4 is a right side elevational view of the polygonal illuminated hand sign of FIGS. 1 and 1A;

g. FIG. 5 is a top plan view of the polygonal illuminated hand sign of FIGS. 1 and 1A; and

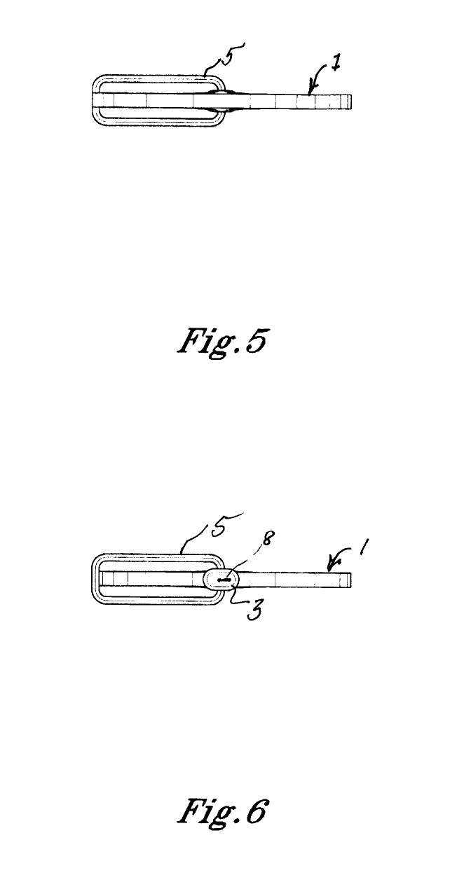

h. FIG. 6 is a bottom plan view of the polygonal hand sign of FIGS. 1 and 1A.

NOTE: While both hexagonal and octagonal overall shapes of the front and rear elevation views of the present invention are disclosed, and while the hexagonal shape has acquired recognition among traffic signs, the present invention contemplates different and additional polygonal overall shapes.

### DETAILED DESCRIPTION

Referring to the accompanying drawings, the illuminated hand sign, generally indicated by the numeral 1, includes an illuminated face section 4s, 4g, 14s, 14g, a handle 3, 13 for supporting or holding the face section; the handle 3, 13 extending from one edge of the polygonal surface, and a strap 5,15 which may be flexible or rigidly formed for carrying the sign when it is not in use.

The illuminated sign contains powered illuminating elements inside of and between the two surfaces 4S and 4G. One of the face sections 4s having the word “Stop” formed thereon, and the other face section 4g having the word “Go” formed thereon, as examples of information that can be displayed to oncoming traffic. The illumination will shine through at least a portion of the surface of the face sections 4s, 4g, such that the entire surface may be transparent or translucent and the words be opaque or the word portion can have a different color from the illuminated portion or the word portions may be the only part illuminated, depending upon the nature of the material forming each portion of the face sections, i.e., transparent, translucent or opaque.

A separate switch may be provided together with a power source, e.g., a battery, a solar power source plus a rechargeable battery, or it may be tethered to a power source (for example, an electrical connection) for powering the illumination elements. The illumination elements may be any of the available lighting elements, including by way of example, fluorescent, LED, incandescent, halogen or other known types of lighting. The strength of the lighting depends upon the intended use and the speed of traffic on any particular road, so as to determine the distance from which the sign may be visible.

A switch 8 may be located on the handle, such as on the bottom of the handle (as shown, for example, in FIG. 6), or may be of the type that will activate when the handle is gripped and remain on as long as the handle is held by a human hand. Such grip can initiate the illumination by the change in temperature resulting from holding the handle, by dielectric change, or by pressure being exerted.

Further, the surface forming the e.g., “Stop” and “Go” wording, can be colored in the usual internationally accepted colors, i.e., red for “Stop” and green for “Go”, or the illuminating elements may provide light of an indicated color such that there would be two lights and there need be a separation between the surfaces such that the light will be directed solely towards the relevant word, i.e., red light to the word “STOP” and green light to the word “GO”.

The handle 3 may be made of a variety of materials, such as metals, polymeric materials or even wood. The face sections 4s, 4g, can be made of polymer materials, that are opaque, translucent of transparent. The front and rear surfaces may be different depending upon the color desired and whether the overall surface or only the words are to be illuminated. Similarly, the handle can be molded as a single unit with at least half of the sign and then the two halves connected together in a known manner; or a separate handle can be formed which would be connected to the sign by the bolts or rivets 21 shown in FIGS. 1A and 2A. The strap 5, 15 may be of a flexible material such as leather or a polymer or a vegetable material, such as a woven rope, or the strap can be molded out of a rigid material such as a polymer or metal.

The switch 8 can be placed as shown on the handle, or the illumination can be turned on as explained above. The switch can be placed on the bottom of the handle, as shown in FIG. 6, so as to avoid being inadvertently moved when laying the sign down on its side.

The above descriptions are intended to be exemplary of the invention only. The claimed exclusive rights of the applicant are to be determined by the following claims.

What is claimed is:

1. A hand-held, illuminated traffic sign comprising a handle secured to a sign comprising
a sign portion comprising front face portion bearing traffic information lettering and a back face portion bearing other traffic information,
at least one illuminating element inside of the sign portion, located between the from and back face portions;
the portion of the sign comprising the information or the portion surrounding the information being capable of passing light from the illuminating element located inside the sign portion, and
a source of power for the illuminating element and a switch element for connecting the source of power to the illuminating element to illuminate the traffic information.

2. The hand-held, illuminated traffic sign of claim 1, wherein the switch is located on the handle.
